(19) United States
(12) Patent Application Publication
(10) Pub. No.: US 2010/0155364 A1
(43) Pub. Date: Jun. 24, 2010

(54) MAGNETIC WRITE HEAD HAVING A STEPPED TRAILING SHIELD AND WRITE POLE WITH A SLOPED TRAILING EDGE

(76) Inventors: Aron Pentek, San Jose, CA (US); Sue Siyang Zhang, Saratoga, CA (US); Yi Zheng, San Ramon, CA (US)

Correspondence Address: ZILKA-KOTAB, PC- HIT, P.O. BOX 721120, SAN JOSE, CA, 95172-1120, US

(21) Appl. No.: 12/343,726

(22) Filed: Dec. 24, 2008

(51) Int. Cl. B44C 1/22

(52) U.S. Cl. 216/11

(57) ABSTRACT

A method for manufacturing a magnetic write head having a write pole a tapered trailing edge and a trailing, wrap-around magnetic shield with a slanted bump structure that steps away from the magnetic write pole. The method involves first forming a write pole and non-magnetic side gap layers, and then depositing a non-magnetic RIEable material. A mask is formed on the RIEable material and a reactive ion etching (RIE) is performed to form the RIEable material layer into a nonmagnetic bump with a tapered front edge.

### FIELD OF THE INVENTION

The present invention relates to perpendicular magnetic recording and more particularly to a magnetic write head having a write pole with a tapered trailing edge for increased write field strength at small bit length dimensions, and having a write pole with a sloped trailing edge.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs, a GMR or TMR sensor has been employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos θ, where θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

### SUMMARY OF THE INVENTION

The present invention provides method for manufacturing a magnetic write head that includes, providing a substrate and then forming a write pole on the substrate, the write pole having first and second laterally opposed sides. A non-magnetic side gap is formed on each of the first and second sides of the write pole. Then, after forming the write pole and the non-magnetic side gaps, a RIEable material layer is deposited over the write pole. A photoresist mask is then formed over the RIEable layer, the photoresist mask having a front located at a back edge of a desired non-magnetic bump taper. Then, a reactive on etching is performed to remove portions of the RIEable layer that are not protected by the photoresist mask, thereby forming a tapered edge on the RIEable layer. The resist mask can then be removed, and an ion milling is performed to remove a portion of the write pole material that is not protected by the remaining RIEable layer to form a tapered trailing edge on the write pole.

The method allows a trailing shield to be formed with a tapered step so that it steps away from the write pole to prevent write field from being lost to the shield. In addition, the method allows the write pole to be formed with a tapered edge for maximizing write field at small bit sizes.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic head according to an embodiment of the present invention;

FIG. 4 shows a detailed view of a write pole and non-magnetic bump layer of the write head of FIG. 3;

FIGS. 5-14 show a portion of a write head in various intermediate stages of manufacture illustrating a method for manufacturing a write head according to an embodiment of the invention;

FIGS. 15-17 show a portion of a magnetic write head in various intermediate stages of manufacture, illustrating a method of manufacturing a write head according to an alternate embodiment of the invention; and

FIGS. 18-21 show a portion of a magnetic write head in various intermediate stages of manufacture, illustrating a method of manufacturing a write head according to yet another embodiment of the invention.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

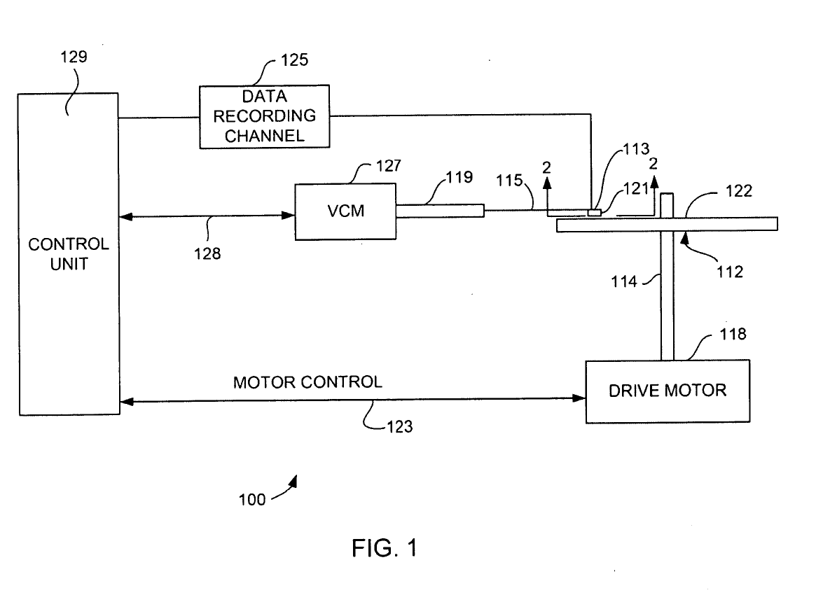

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

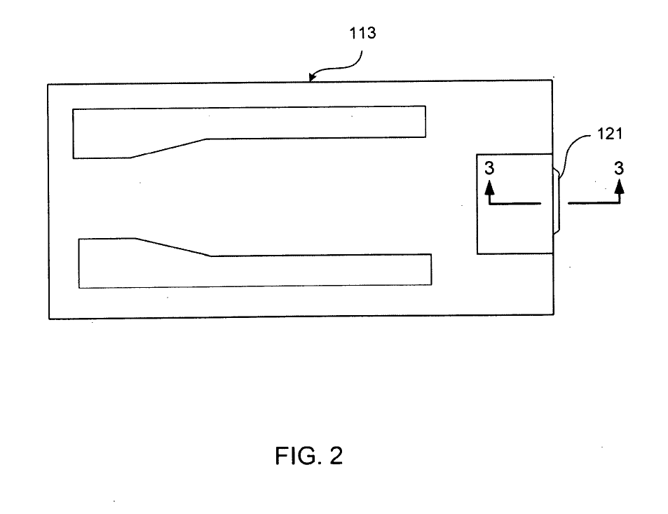

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

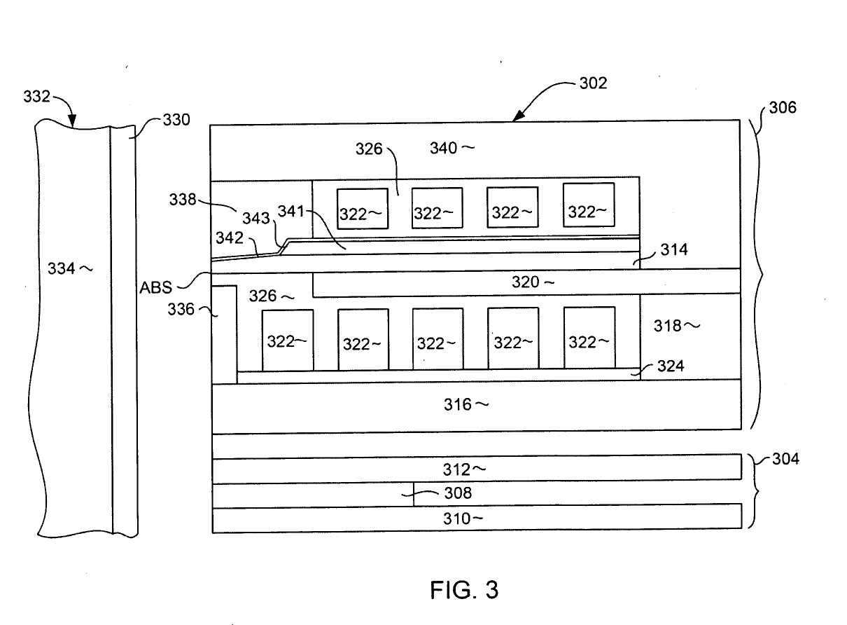

With reference now to FIG. 3, the invention can be embodied in a magnetic head 302. The magnetic head 302 includes a read head 304 and a write head 306. The read head 304 includes a magnetoresistive sensor 308, which can be a GMR, TMR, or some other type of sensor. The magnetoresistive sensor 308 is located between first and second magnetic shields 310, 312.

The write head 306 includes a magnetic write pole 314 and a magnetic return pole 316. The write pole 314 can be formed upon a magnetic shaping layer 320, and a magnetic back gap layer 318 magnetically connects the write pole 314 and shaping layer 320 with the return pole 316 in a region removed from the air bearing surface (ABS). A write coil 322 (shown in cross section in FIG. 3) passes between the write pole and shaping layer 314, 320 and the return pole 316, and may also pass above the write pole 314 and shaping layer 320. The write coil 322 can be a helical coil or can be one or more pancake coils. The write coil 322 can be formed upon an insulation layer 324 and can be embedded in a coil insulation layer 326 such as alumina and or hard baked photoresist.

In operation, when an electrical current flows through the write coil 322, a resulting magnetic field causes a magnetic flux to flow through the return pole 316, back gap 318, shaping layer 320 and write pole 314. This causes a magnetic write field to be emitted from the tip of the write pole 314 toward a magnetic medium 332. The write pole 314 has a cross section at the ABS that is much smaller than the cross section of the return pole 316 at the ABS. Therefore, the magnetic field emitting from the write pole 314 is sufficiently dense and strong that it can write a data bit to a magnetically hard top layer 330 of the magnetic medium 332. The magnetic flux then flows through a magnetically softer under-layer 334, and returns back to the return pole 316, where it is sufficiently spread out and weak that it does not erase the data bit recorded by the write pole 314. A magnetic pedestal 336 may be provided at the air bearing surface ABS and attached to the return pole 316 to prevent stray magnetic fields from the bottom leads of the write coil 322 from affecting the mapetic signal recorded to the medium 332.

In order to increase write field gradient, and therefore increase the speed with which the write head 306 can write data, a trailing, wrap-around magnetic shield 338 can be provided. The trailing, wrap-around magnetic shield 338 is separated from the write pole by a non-magnetic layer 339. The shield 338 also has side shielding portions that are separated from sides of the write pole by non-magnetic side gap layers. The side portions of the shield 338 and side gap portions are not shown in FIG. 3, but will be described in greater detail herein below. The trailing shield 338 attracts the magnetic field from the write pole 314, which slightly cants the angle of the magnetic field emitting from the write pole 314. This canting of the write field increases the speed with which write field polarity can be switched by increasing the field gradient. A trailing magnetic return pole 340 can be provided and can be magnetically connected with the trailing shield 338. Therefore, the trailing return pole 340 can magnetically connect the trailing magnetic shield 338 with the back portion of the write pole 302, such as with the back end of the shaping layer 320 and with the back gap layer 318. The magnetic trailing shield is also a second return pole so that in addition to magnetic flux being conducted through the medium 332 to the return pole 316, the magnetic flux also flows through the medium 332 to the trailing return pole 340.

In order to increase data density in a magnetic data recording system, the bit length of the recorded data bits must be decreased. This requires a reduction of the write pole thickness as measured from the trailing edge to the leading edge of the write pole 314. However, this reduction in write pole thickness risks magnetically saturating the write pole so that magnetic flux to the tip of the write pole 314 can become choked off, thereby reducing write field strength. In order to mitigate this, the write pole 314 has a tapered trailing edge 342 so that the thickness of the write pole can gradually increase. In addition, a non-magnetic bump 341 having a tapered front edge 343 spaces the trailing shield 338 from the write pole 314 in a region removed from the ABS. This tapered stepped shape of the bump 341 advantageously minimizes the amount of magnetic flux that can leak from the write pole 314 to the trailing magnetic shield 338, while also avoiding magnetic saturation of the trailing shield 338. Therefore, as can be seen, the write pole 314 and trailing shield 338 each have an optimal shape for maximizing write field at very small bit sizes.

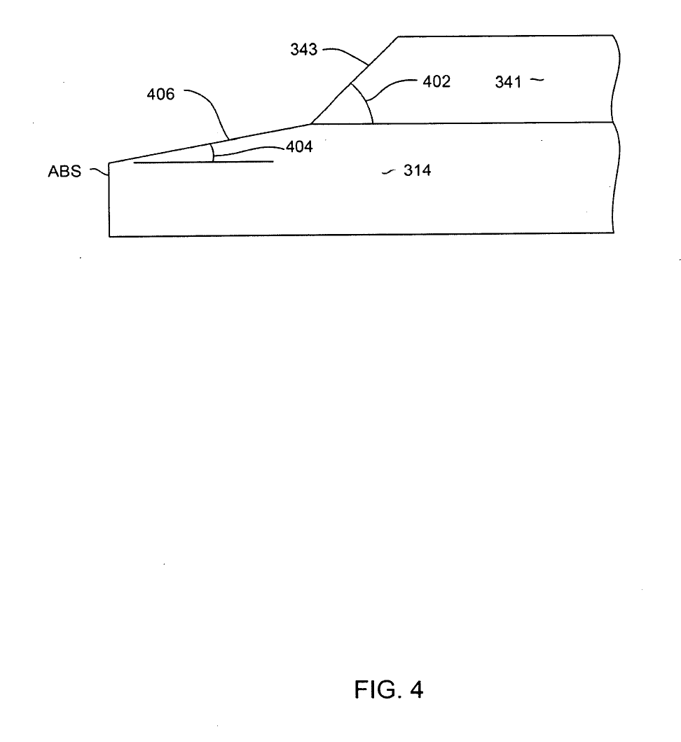

FIG. 4 is enlarged view of a portion of the write pole 314, and tapered, non-magnetic bump 341. As can be seen, the bump has a front edge 343 that defines an angle 402 of 40-50 degrees or about 45 degrees with respect to the plane of as deposited layers (i.e. relative to a plane that is perpendicular to the air bearing surface ABS. In addition, it can be seen that the write pole 314 has a tapered trailing edge 406 that forms an angle 404 of 10-30 degrees or about 20 degrees with respect to the plane of the as deposited layer. These angles have been found to provide optimal write head performance.

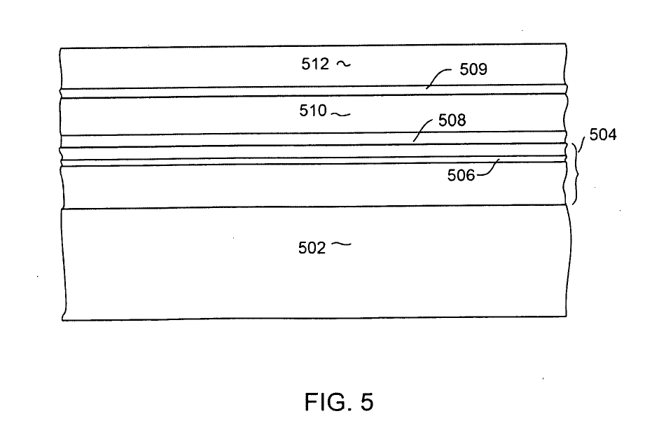

With reference now to FIGS. 5-14, a method for manufacturing a write head according to an embodiment of the invention is described. With particular reference to FIG. 5, a substrate 502 is provided. A write pole material 504 is deposited over the substrate. The write pole material 504 can be a laminated structure that includes multiple magnetic layers separated by thin non-magnetic layers. The write pole material 504 can also include an end point detection layer 506 interspersed therein. This layer 506 can function as one of the thin non-magnetic layers just mentioned. The end point detection layer 506 can be a material that can be easily detected by an end point detection method such as Secondary Ion Mass Spectrometry (SIMS), such as a material containing Ni.

A hard mask layer 508 can be deposited over the magnetic write pole material 504. The hard mask layer 508 can be alumina and can be one or more of other materials. An image transfer layer 510 can be deposited over the hard mask layer 508. The image transfer layer 510 can be soluble polyimide material such as DURAMIDE®. A second hard mask layer 509 can be deposited over the image transfer layer, and a resist layer 512 can be deposited over the second hard mask 509.

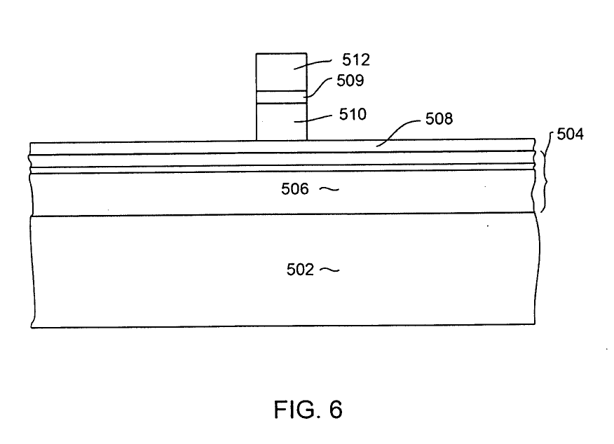

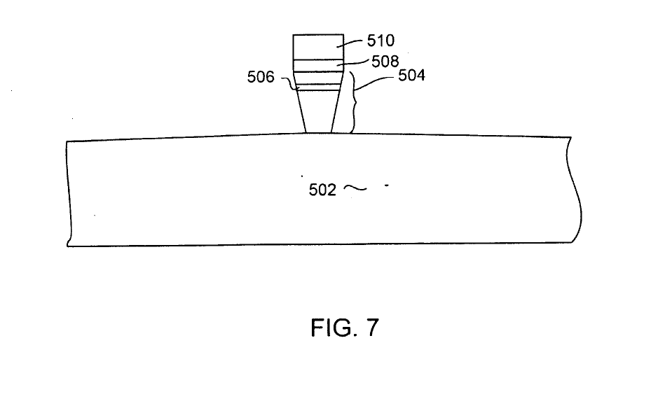

With reference to FIG. 6, the resist layer 512 is then photolithographically patterned and developed to define a write pole shape. The pattern of the resist layer 512 is then transferred onto the underlying hard mask and image transfer layer 509, 510, such as by a reactive ion etching process. Then, with reference to FIG. 7, an ion milling is performed to remove portions of the write pole material that are not protected by the hard mask 508 and image transfer layer 510.

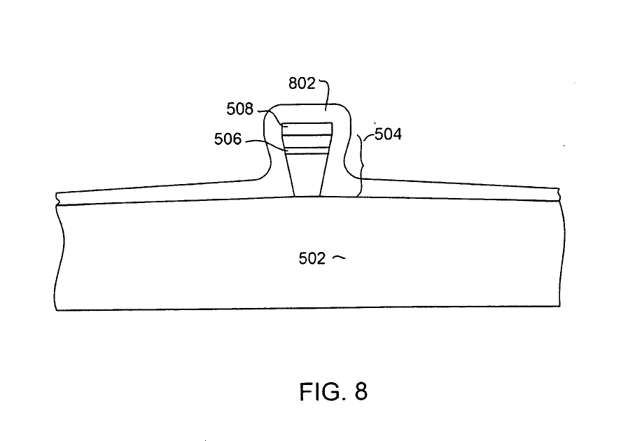

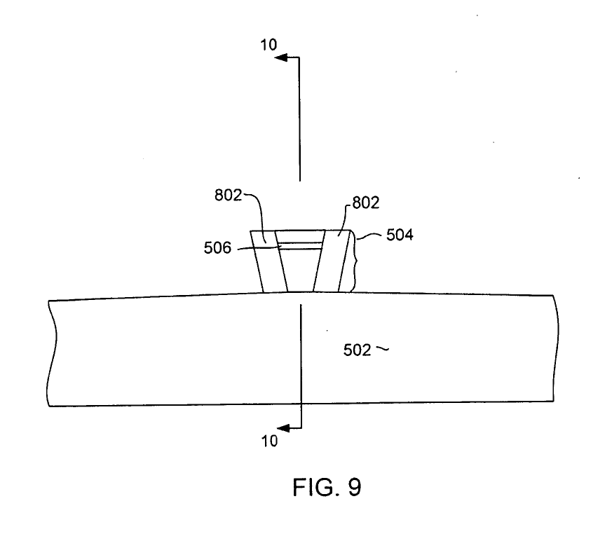

Then, with reference to FIG. 8, the residual image transfer layer 510 is removed by a chemical strip process. Next, a layer of alumina 802 is deposited by a conformal deposition process such as atomic layer deposition. A material removal process such as ion milling can then be performed to preferentially remove horizontally disposed portions of the alumina layer 802, leaving alumina side walls 802 as shown in FIG. 9.

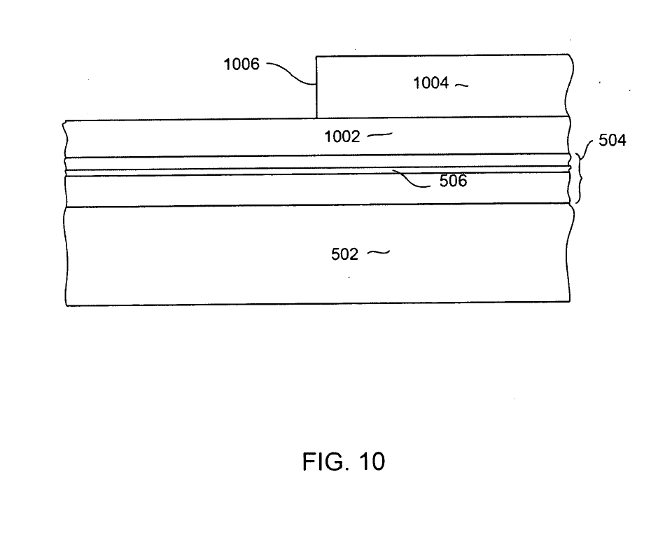

FIG. 10 shows a side view as taken from line 10-10 of FIG. 9. While FIG. 5-9 were views of a cross sectional plane that is parallel with the air bearing surface, FIG. 10 is a view of a cross sectional plane that is perpendicular to the air bearing surface. With reference then to FIG. 10, a non-magnetic layer 1002 of material that can be removed by reactive ion etching is deposited. This layer can be constructed of a material such as Ta, TaOₓ, SiC, SiO₂ or SiNₓ, and will be referred to herein as RIEable layer 1002. This layer can be, for example 50-60 nm thick. A resist layer 1004 is deposited over the RIEable layer 1002, and is photolithographically patterned and developed to form a mask structure having a front edge 1006 that is located so as to define a back edge of a step taper as will be understood more clearly below.

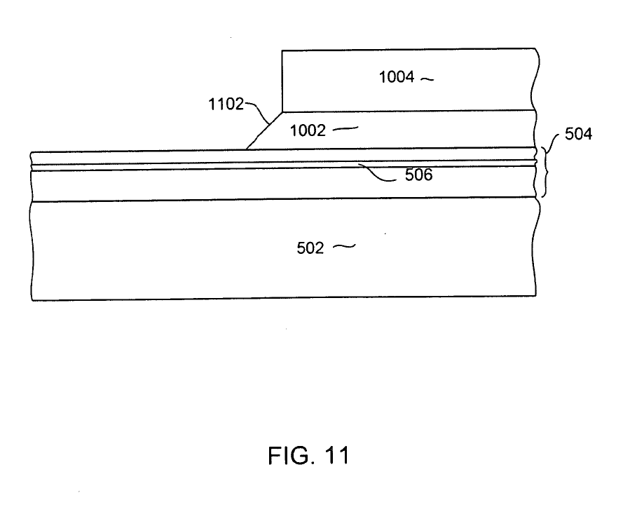

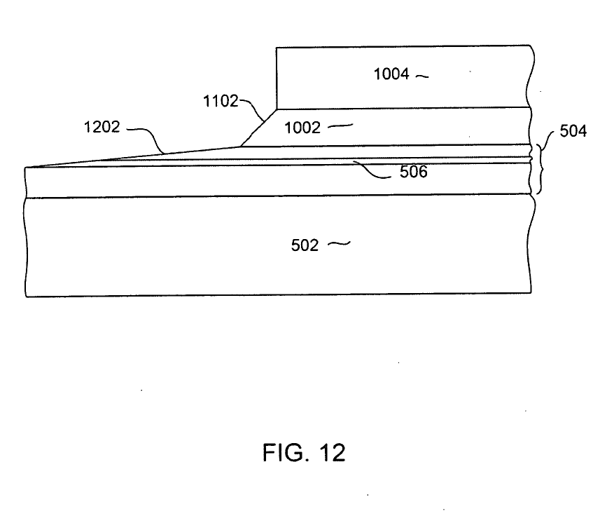

Then, a reactive ion etching process is performed to remove portions of the REIable layer 1002 that are not protected by the mask 1004. The resist material 1004 can then be stripped off, leaving a structure such as that shown in FIG. 11. The reactive ion etching RIE using Fluorine chemistry can be performed in a manner so as to form the front edge 1102 of the RIEable layer 1002 with a taper as shown in FIG. 11. The taper angle is controlled by careful selection of etch gas and process conditions using techniques well know to those skilled in the art. Then, with reference to FIG. 12, a short ion milling process is performed to remove a portion of the write pole material to form a tapered trailing edge 1202 on the write pole material. The tapered trailing edge 1202 has a shallow angle of 10-30 degrees or about 20 degrees relative to the plane of the deposited layers, whereas the end 1102 of the RIEable material 1002 has a higher angle of 40-50 degrees or about 45 degrees with respect to the plane of the deposited layers. An end point detection method such a Secondary Ion Mass Spectrometery (SIMS) can be used to detect when the end point detection layer 506 has been reached, so that the ion milling can be terminated when the end point detection layer has been reached.

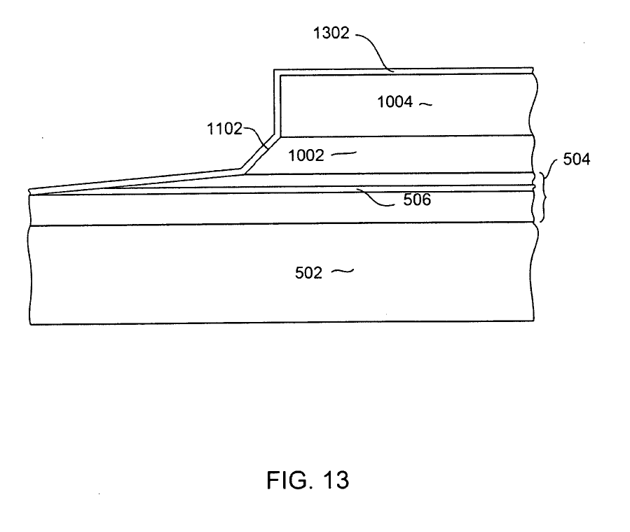

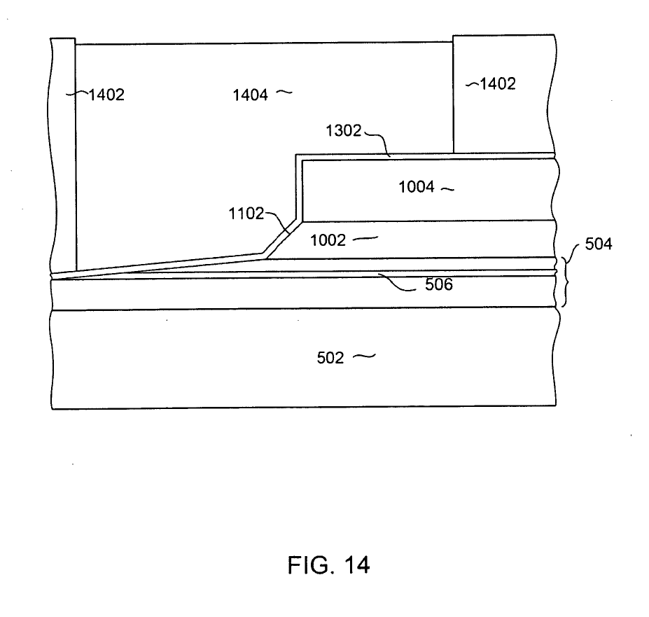

Then, with reference to FIG. 13, a non-magnetic, electrically conductive gap layer 1302 can be deposited. This gap layer 1302 is deposited to a thickness that is chosen to define a desired trailing gap for the trailing shield (yet to be formed). Then, with reference to FIG. 14, a mask structure 1402 is formed having an opening that is configured to define a desired shape of a wrap-around, trailing magnetic shield. The mask can be formed of a photolithographically patterned photoresist. A magnetic material such as CoFe or NiFe can then be electroplated into the opening in the mask 1402 to form a magnetic shield, such as the shield 338 described above with reference to FIG. 3. The electrically conductive, non-magnetic gap layer 1302 can be used as an electroplating seed layer for the electroplating process.

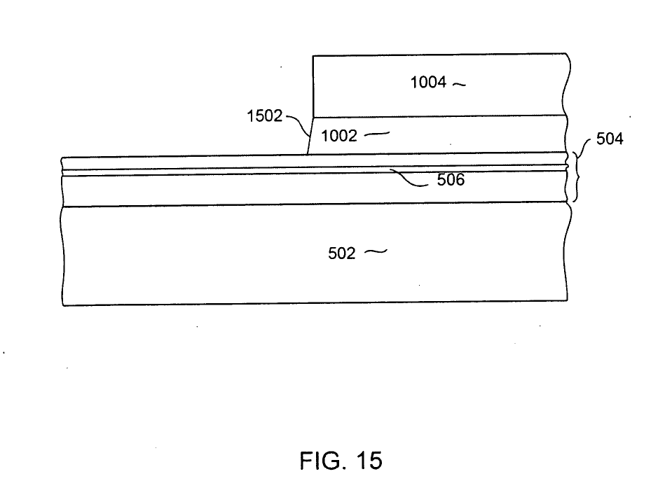

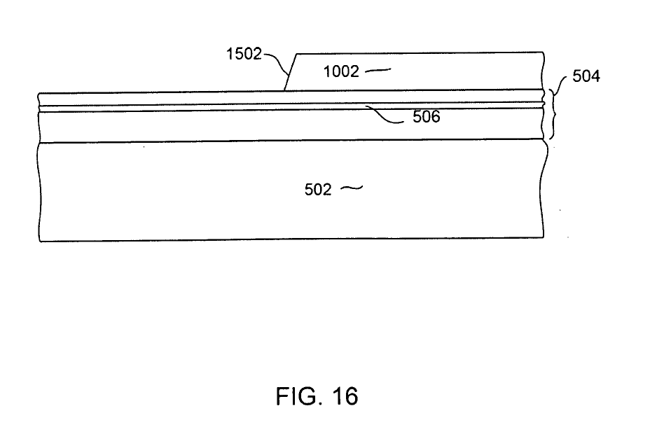

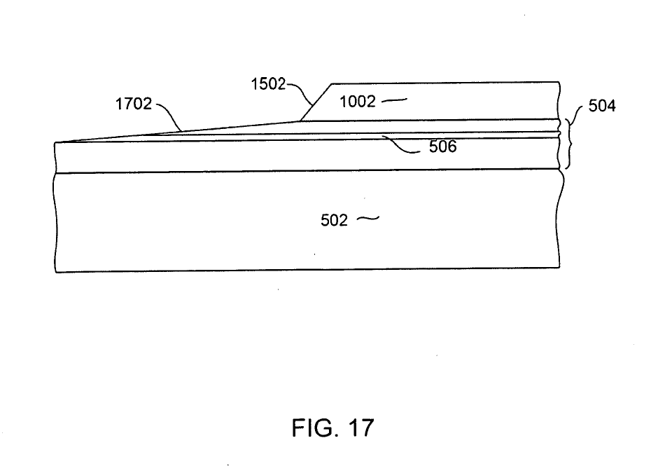

FIGS. 15 through 17 illustrate a slightly modified method for manufacturing a write head. Starting with a structure such as shown in FIG. 10, a reactive ion etching process using Fluorine chemistry is performed to form an edge 1502 that is only slightly tapered. The taper angle is controlled by careful selection of etch gas and process conditions using techniques well know to those skilled in the art. The resist mask 1002 can then be lifted off, leaving a structure as shown in FIG. 16. Then, an ion milling can be performed to further taper the edge 1502 of the RIEble layer 1002 and to also remove a portion of the magnetic write pole layer 504 to form a slightly tapered trailing edge 1702. As with the previously described embodiment the end point detection layer 506 can be used to determine when the ion milling should be terminated. A non-magnetic gap layer can then be deposited and a trailing shield formed, as described above with reference to FIGS. 13 and 14.

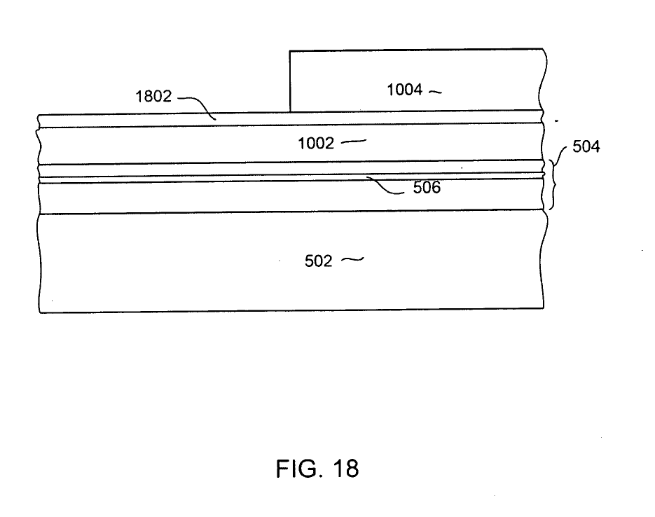

FIGS. 18 through 21 illustrate yet another embodiment for manufacturing a write pole. FIG. 18 shows a structure similar to that of FIG. 10, except that a second layer 1802 is deposited over the RIEable layer 1802 and beneath the mask 1004. The second layer can function as an image transfer layer, and provides greater selectivity for reactive ion etching. The second layer 1802, therefore, can be constructed either of a RIEable of a material such as diamond like carbon (DLC) or a thin metal layer like Cr or NiCr

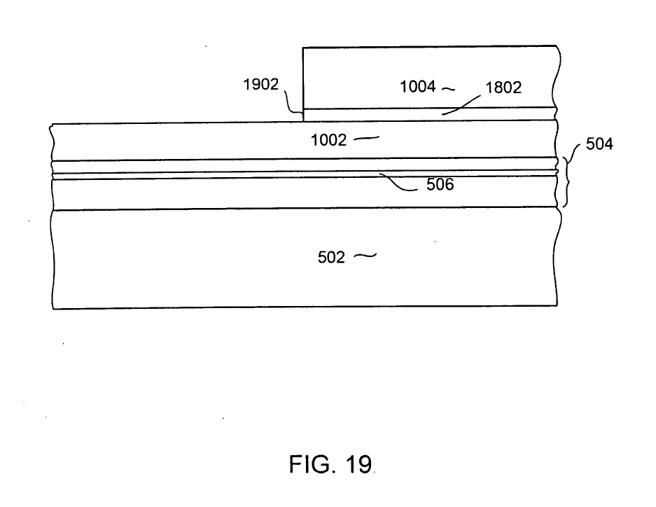

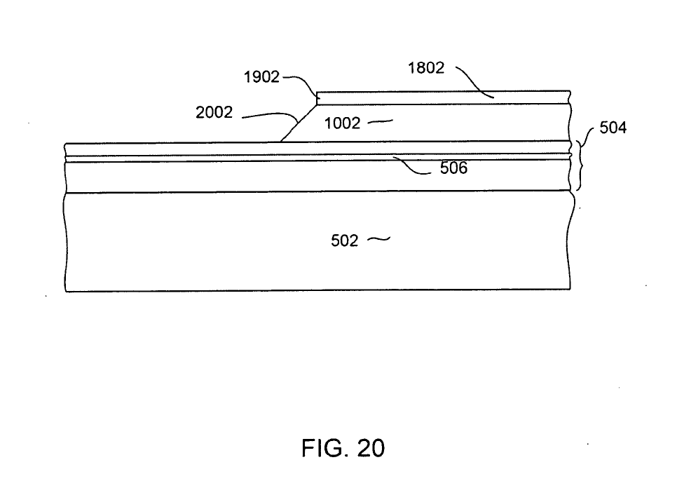

With reference to FIG. 19 a first etching is performed to transfer the image of the resist mask 1004 onto the underlying layer 1802. If layer 1802 is DLC, this can be performed using reactive ion etch in an O₂ or CO₂ chemistry and results in a substantially vertical edge 1902 on the layer 1802. If the layer 1802 is a metal layer, ion beam etch can be used with Ar ions to achieve a substantially vertical edge 1902. Then a chemical strip process is used to remove the photoresist 1004. Next, with reference to FIG. 20, a second reactive ion etching can be performed to form a tapered front edge 2002 on the first RIEable layer 1002. As with the above described embodiment, this second RIE can be performed using a Fluorine chemistry to form the tapered edge 2002 with an angle of 40-50 degrees relative to the plane of the deposited layers.

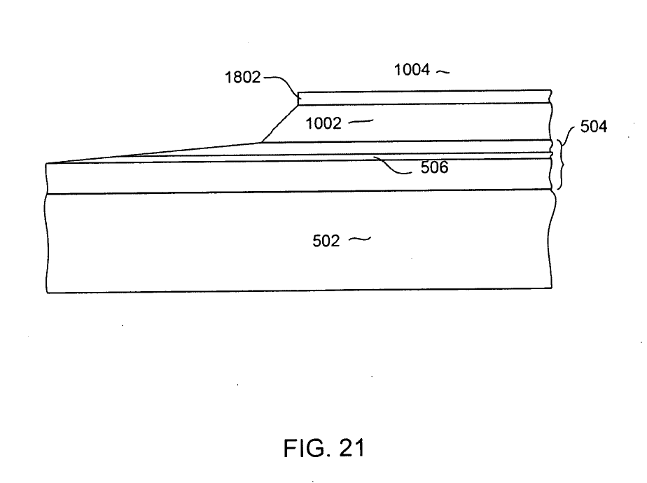

Then, with reference to FIG. 21, an ion milling can be used to form a tapered trailing edge 2102 on the write pole, the ion milling being terminated when the end point detection layer 506 has been reached. As with the previously described embodiments, a layer non-magnetic gap layer 1302 can be deposited and a trailing magnetic shield material 1404 electroplated as described above with reference to FIGS. 13 and 14.

The above described processes produce a write pole with a slanted trailing shield bump and tapered write pole leading edge. This bump and taper are formed after the fabrication of the write pole has been fabricated and after the non-magnetic side gap layers have been formed. This avoids fabrication process difficulties associated with fabricating a bump or taper before the write pole has been formed.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic write head, comprising:
providing a substrate;
forming a write pole on the substrate, the write pole having first and second laterally opposed sides;
forming a non-magnetic side gap on each of the first and second sides of the write pole;
after forming the write pole and the non-magnetic side gaps, depositing a RIEable layer over the write pole;
forming a photoresist mask over the RIEable layer, the photoresist mask having a front located at a back edge of a desired non-magnetic bump taper;
performing a reactive on etch to remove portions of the RIEable layer that are not protected by the photoresist mask, thereby forming a tapered edge on the RIEable layer;
removing the resist mask; and
performing an ion milling to remove a portion of the write pole material that is not protected by the remaining RIEable layer to form a tapered trailing edge on the write pole.

2. A method as in claim 1 wherein the write pole includes a magnetic material with and end point detection disposed therein, and wherein the ion milling is terminated when the end point detection layer.

3. A method as in claim 2 wherein the end point detection layer comprises Ni, and wherein Secondary Ion Mass Spectrometry is used to determine when the end point detection layer has been reached.

4. A method as in claim 1 further comprising, after performing the ion milling:
depositing a non-magnetic, electrically conductive gap layer;
forming a mask second mask structure having an opening configured to define a trailing, wrap-around shield; and
electroplating a magnetic material into the opening in the second mask structure.

5. A method as in claim 4 wherein the metal gap layer comprises Rh or Ru.

6. A method as in claim 1 wherein the RIEable layer comprises Ta, TaOₓ, SiC, SiO₂ or SiNₓ.

7. A method as in claim 1 wherein the reactive ion etching is performed in a manner to form a tapered edge that defines an angle of 40-50 degrees with respect to a plane of the as deposited layers.

8. A method as in claim 1 wherein the ion milling is performed in a manner to form a tapered trailing edge on the write pole that defines an angle of 10-30 degrees with respect to the as deposited layers.

9. A method as in claim 1 wherein the reactive ion etching is performed in a manner to form a tapered edge on the RIEable layer that forms an angle of 40-50 degrees with respect to a plane of the as deposited layers, and wherein the ion beam etching is performed in a manner to form a tapered trailing edge on the write pole that defines an angle of 10-30 degrees with respect to normal.

10. A method as in claim 1 wherein the reactive ion etching is performed in a manner to form a tapered edge that defines an angle of about 45 degrees with respect to a plane of the as deposited layers.

11. A method as in claim 1 wherein the ion milling is performed in a manner to form a tapered trailing edge on the write pole that defines an angle of about 20 degrees with respect to the as deposited layers.

12. A method as in claim 1 wherein the reactive ion etching is performed in a manner to form a tapered edge on the RIEable layer that forms an angle of about 45 degrees with respect to a plane of the as deposited layers, and wherein the reactive ion etching is performed in a manner to form a tapered trailing edge on the write pole that defines an angle of about 20 degrees with respect to normal.

13. A. method as in claim 1 wherein the reactive ion etching is performed in a manner to form and edge on the RIEable layer with only a slight taper, and wherein the ion milling is performed in a manner that forms a tapered edge on the RIEable layer that defines an angle of 40-50 degrees with respect to a plane of the as deposited layers, and also to form a tapered trailing edge on the write pole that defines an angle of 10-30 degrees with respect to normal.

14. A method as in claim 1 wherein the reactive ion etching is performed in a manner to form and edge on the RIEable layer with only a slight taper, and wherein the ion milling is performed in a manner that forms a tapered edge on the RIEable layer that defines an angle of about 45 degrees with respect to a plane of the as deposited layers, and also to form a tapered trailing edge on the write pole that defines an angle of about 20 degrees with respect to normal.

15. A method for manufacturing a magnetic write head, comprising:
providing a substrate;
forming a write pole on the substrate, the write pole having first and second laterally opposed sides;
forming a non-magnetic side gap on each of the first and second sides of the write pole;
after forming the write pole and the non-magnetic side gaps, depositing a first RIEable layer over the write pole;
depositing a second RIEable layer over the first REIable layer;
forming a photoresist mask over the RIEable layer, the photoresist mask having a front located at a back edge of a desired non-magnetic bump taper;
performing a first reactive ion etch to transfer the pattern of the photoresist mask onto the second RIEable layer;
performing a second reactive on etch to remove portions of the second RIEable layer that are not protected by the photoresist mask, the second reactive ion etch being performed in a manner so as to form a tapered edge on the second RIEable layer;
removing the resist mask; and
performing an ion milling to remove a portion of the write pole material that is not protected by the remaining RIEable layer to form a tapered trailing edge on the write pole.

16. A method as in claim 15 wherein the first RIEable layer comprises Ta, TaOₓ, SiC, SiO₂ or SiNₓ.

17. A method as in claim 15 wherein the second RIEable layer comprises DLC.

18. A method as in claim 15 wherein the first RIEable layer comprises Ta, TaOₓ, SiC, SiO₂ or SiNₓ, and wherein the second RIEable layer comprises DLC.

19. A method as in claim 15 wherein the write pole includes a magnetic material with and end point detection disposed therein, and wherein the ion milling is terminated when the end point detection layer.

20. A method as in claim 19 wherein the end point detection layer comprises Ni, and wherein Secondary Ion Mass Spectrometry is used to determine when the end point detection layer has been reached.

21. A method for manufacturing a magnetic write head, comprising:
providing a substrate;
forming a write pole on the substrate, the write pole having first and second laterally opposed sides;
forming a non-magnetic side gap on each of the first and second sides of the write pole;
after forming the write pole and the non-magnetic side gaps, depositing a first RIEable layer over the write pole;
depositing a second metal layer over the first RIEable layer;
forming a photoresist mask over the RIEable layer, the photoresist mask having a front located at a back edge of a desired non-magnetic bump taper;
performing a ion beam etch to transfer the pattern of the photoresist mask onto the second RIEable layer;
performing a second reactive on etch to remove portions of the second RIEable layer that are not protected by the photoresist mask, the second reactive ion etch being performed in a manner so as to form a tapered edge on the second RIEable layer;
removing the resist mask; and
performing an ion milling to remove a portion of the write pole material that is not protected by the remaining RIEable layer to form a tapered trailing edge on the write pole.

22. A method as in claim 15 wherein the first RIEable layer comprises Ta, TaOₓ, SiC, SiO₂ or SiNₓ.

23. A method as in claim 15 wherein the second metal layer comprises Ni, NiCr.

24. A method as in claim 15 wherein the first RIEable layer comprises Ta, TaOₓ, SiC, SiO₂ or SiNₓ, and wherein the second RIEable layer comprises DLC.
